(19) United States
(12) Patent Application Publication
(10) Pub. No.: US 2026/0130352 A1
(43) Pub. Date: May 14, 2026

(54) DEVICE FOR BRAKING DIAL ADJUSTMENT OF FISHING REEL

(71) Applicants: Pure Fishing, Inc., Columbia, SC (US); Jia Dun Sports Equipment Co., Ltd., Guangzhou (CN)

(72) Inventors: Yingdong QI, Guangzhou (CN); Sheng LI, Guangzhou (CN); Guohua ZANG, Guangzhou (CN); Liang HUANG, Guangzhou (CN)

(21) Appl. No.: 19/354,814

(22) Filed: Oct. 9, 2025

(30) Foreign Application Priority Data
Nov. 13, 2024 (CN) 2024116207369.9

(51) Int. Cl. A01K 89/033

(52) U.S. Cl. CPC A01K 89/051; A01K 89/056

(57) ABSTRACT

A device for braking dial adjustment of a fishing reel is disclosed. The fishing reel includes a body, a first end portion, a spool portion and a braking portion. The device for braking dial adjustment of a fishing reel includes a knob, a first transmission member and a second transmission member. The knob is rotatably mounted to a top portion of a side cover. An axial end of the first transmission member is coaxially connected with the knob, and another end of the first transmission member extends towards an end cover. An axial end of the second transmission member is in transmission connection with the first transmission member, and another end of the second transmission member penetrates through the end cover and is connected with a braking-dial input portion.

### CROSS-REFERENCE TO RELATED APPLICATION

This application is based on and claims the benefit of priority from Chinese Patent Application No. 2024116207369, filed on 13 Nov. 2024, the entirety of which is incorporated by reference herein.

### TECHNICAL FIELD

The present disclosure relates to the technical field of fishing reels, and in particular to a device for braking dial adjustment of a fishing reel.

### BACKGROUND

In a fishing reel, such as a baitcasting reel, excessive spool rotation speed during a cast can cause the line to leave the spool faster than the lure travels. This causes the line to bunch up around the spool, resulting in “backlash”. To prevent this, a brake system is mounted that applies braking force to the spool. In such brake system, the braking force is generated through cooperation between a coil and a magnet. Furthermore, the braking dial is adjusted by a knob, thus adjusting the magnitude of the braking force.

Because the printed circuit board is mounted coaxially with the spool shaft, the identification pattern used for identifying a rotation position of the knob needs to be arranged at the periphery of the circuit board to avoid a central position of the circuit board. Correspondingly, the knob is also arranged at an eccentric position relative to a rotation center of the spool. As the knob is arranged in the eccentric position relative to the rotation center of the spool, when an angler operates the fishing reel, the knob may be rotated due to mis-operation of the angler (e.g., by the angler's thumb), which may lead to the braking dial being changed. In addition, due to a limited setting position, the entire knob is set to be relatively small, which may also affect normal operation of the angler.

### PRIOR ART REFERENCES

### Patent references

Patent reference 1: China Patent Publication No. 1965645

### SUMMARY

In view of the above technical problems, the present disclosure aims at providing a device for braking dial adjustment of a fishing reel, which can make it easier to operate a knob for adjusting a braking dial.

In the device for braking dial adjustment of a fishing reel according to the present disclosure, the fishing reel comprises a body, a first end portion, a spool portion and a braking portion.

The first end portion is provided with an end cover and a side cover, the end cover is mounted at an axial end of the body, and the side cover covers the end cover.

The spool portion is provided with a spool shaft, and an axial end of the spool shaft is rotatably mounted on the end cover.

The braking portion is provided with a mounting base, a coil, a magnet and a control panel, wherein the mounting base is arranged on one side of the end cover opposite to the side cover; the coil is mounted on one of the mounting base and the spool shaft, the magnet is mounted on another of the mounting base and the spool shaft, and the coil and the magnet are opposite to each other along a radial direction of the spool shaft; and the control panel is mounted on the mounting base and has a braking-dial input portion for switching a level of a braking force generated by the coil and the magnet.

The device for braking dial adjustment of a fishing reel comprises a knob, a first transmission member and a second transmission member.

The knob is rotatably mounted to a top portion of the side cover.

An axial end of the first transmission member is coaxially connected with the knob, and another end of the first transmission member extends towards the end cover.

An axial end of the second transmission member is in transmission connection with the first transmission member, and another end of the second transmission member penetrates through the end cover and is connected with the braking-dial input portion.

The device for braking dial adjustment of a fishing reel according to the present disclosure at least has the beneficial effect of making it easier to operate the knob for adjusting the braking dial.

In some embodiments, the top portion of the side cover protrudes toward an outer side as a side opposite to the end cover; and an outer side of the knob protrudes from an outer side of the top portion of the side cover.

In some embodiments, the side cover is provided with a supporting plate at the top portion, the supporting plate is provided with a first accommodating groove at the outer side, and the knob is accommodated in the first accommodating groove and supported by the supporting plate in an axial direction; and in a state that the knob is accommodated in the first accommodating groove, an outer periphery edge of the knob is in smooth transition with the outer side of the top portion of the side cover.

In some embodiments, a first protruding portion protruding toward the outer side is provided in a middle portion of the supporting plate, and a first round hole extending in the axial direction is provided in the first protruding portion; the first transmission member is mounted to the knob through the first round hole; and the first transmission member or the knob rotatable around an axis of the first round hole.

In some embodiments, the axial end of the first transmission member is provided with a cylindrical portion, which is coaxially accommodated in the first round hole and rotatable around the axis of the first round hole; and one end of the knob opposite to the side cover is provided with a shaft-shaped portion, and the shaft-shaped portion is coaxially inserted into the cylindrical portion and locked.

In some embodiments, the first transmission member and the knob are respectively fixed on the top portion of the side cover with the supporting plate sandwiched between the first transmission member and the knob in the axial direction; and a gap is provided between each of the first transmission member and the knob, and the supporting plate in the axial direction.

In some embodiments, the side cover is provided with a guide portion at an inner side of the side cover, and the guide portion is configured for guiding rotation of the second transmission member.

In some embodiments, the first transmission member is provided with a first transmission end, and the first transmission end is provided with a first gear portion; the second transmission member is provided with a second transmission end, and the second transmission end is coaxially provided with a gear member; and the gear member is rotatable around the guide portion.

In some embodiments, the side cover is provided at the inner side with a cylindrical second protruding portion protruding toward the end cover, and the second protruding portion serves as the guide portion; and the gear member is provided with a mounting hole, the second protruding portion is inserted into the mounting hole, and the gear member is rotatable around the second protruding portion.

In some embodiments, the second transmission member is provided with a supporting step for supporting the gear member; the side cover is provided with a supporting plate at the top portion, and the second protruding portion is provided at an inner side of the supporting plate; and in a state that the second transmission member is connected with the braking-dial input portion and the side cover covers the end cover, a distance between a surface of the supporting step and a surface of the inner side of the supporting plate in the axial direction is greater than a thickness of the gear member.

### BRIEF DESCRIPTION OF THE DRAWINGS

FIG. 1 is a perspective view of a fishing reel of the present disclosure as viewed from a second end portion.

FIG. 2 is a perspective view of the fishing reel of the present disclosure as viewed from a first end portion.

FIG. 3 is a sectional view of a device for braking dial adjustment of a fishing reel according to an embodiment of the present disclosure.

FIG. 4 is a sectional view from the same sectional perspective as FIG. 3.

FIG. 5 is an exploded view of the device for braking dial adjustment of a fishing reel according to an embodiment of the present disclosure.

FIG. 6 is a perspective view of a side cover of the first end portion as viewed from an axial outer side.

FIG. 7 is a perspective view of the side cover of the first end portion as viewed from an axial inner side.

### REFERENCE NUMERALS

101—body; 102—first end portion; 103—second end portion; 104—spool portion; 105—handle; 106—brake system (braking portion); 107—shaft supporting portion; 107a—first bearing; 108 spool shaft; 109—spool cylinder; 110—braking dial adjusting device; 111—end cover; 112—side cover; 113—mounting base; 114—coil; 115—magnet; 116—control panel; 117—braking-dial input portion; 118—knob; 119—first transmission member; 120—second transmission member; 121—base portion; 122—outer side wall; 123—middle wall; 124—mounting lug; 125—accommodating cavity; 126—sealing wall; 127—space; 128—supporting plate; 129—first accommodating groove; 130—transition cover plate; 131—first protruding portion; 132—first round hole; 133—second accommodating groove; 134—first groove portion; 135—second groove portion; 136—first transmission end; 137—second transmission end; 138—second protruding portion; 139—guide portion; 140—dial; 141—shaft—shaped portion; 142—abutting portion; 143—cylindrical portion; 144—first gear portion; 145—second round hole; 146—first screw; 147—mounting cavity; 148—drive end; 149—middle portion; 150—through hole; 151—gear member, 152—supporting step; and 153—mounting hole.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “rear”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “mount”, and “connect” should be understood in a broad sense, and those of ordinary skill in the art can determine the specific meanings of the above words in the present disclosure in a rational way in combination with the specific contents of the technical solutions.

In addition, in the description of the present disclosure, when referring to the description about a shaft and a hole, “same” refers to a fit relationship of the shaft and the hole based on machinery; when referring to the description about diameter, radius, distance, thickness, and the like, “same” refers to the same fit relationship based on machinery, and may have an allowable error (tolerance) for a certain assembly relationship (such as clearance fit). When referring to the description about an axial direction, it refers to an axial direction of a spool shaft. When referring to the description about an outer side and an inner side, with a center of a cross section of an axial middle portion of the spool shaft as a reference, a side farther away from the center in the radial or axial direction of the spool shaft is regarded as the “outer side”, and a side closer to the center in the radial or axial direction is regarded as the “inner side”.

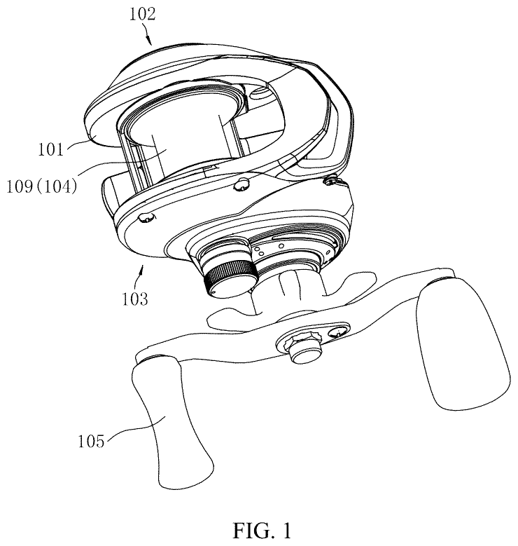

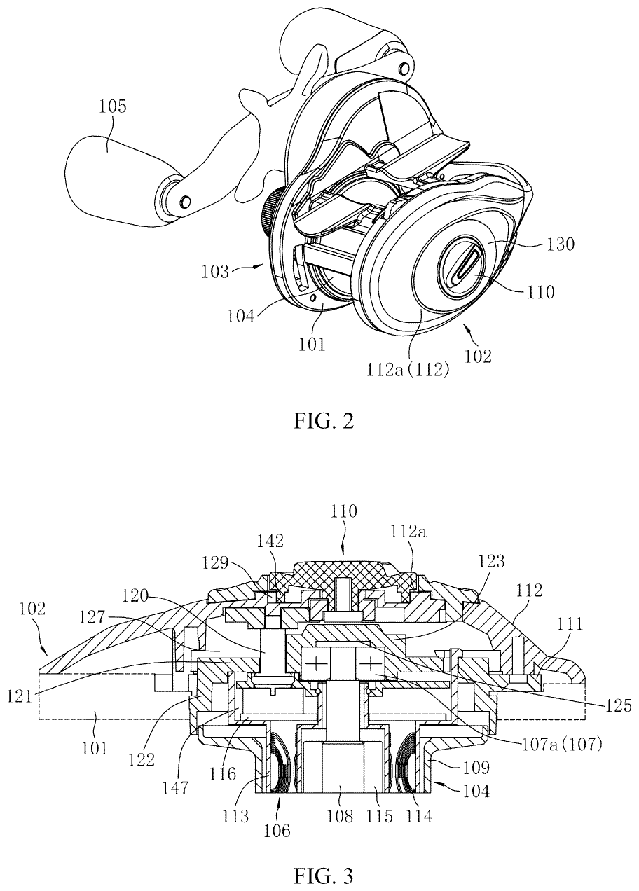

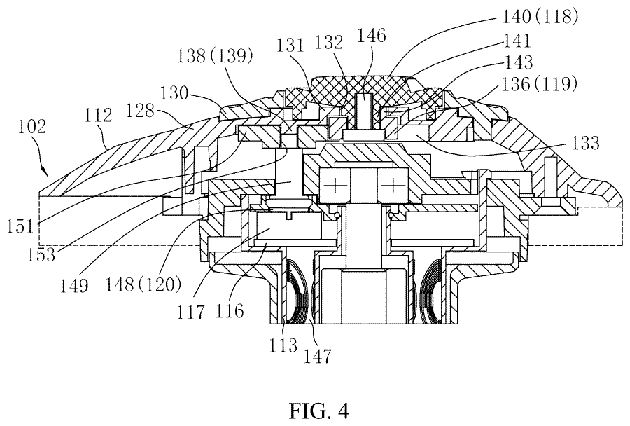

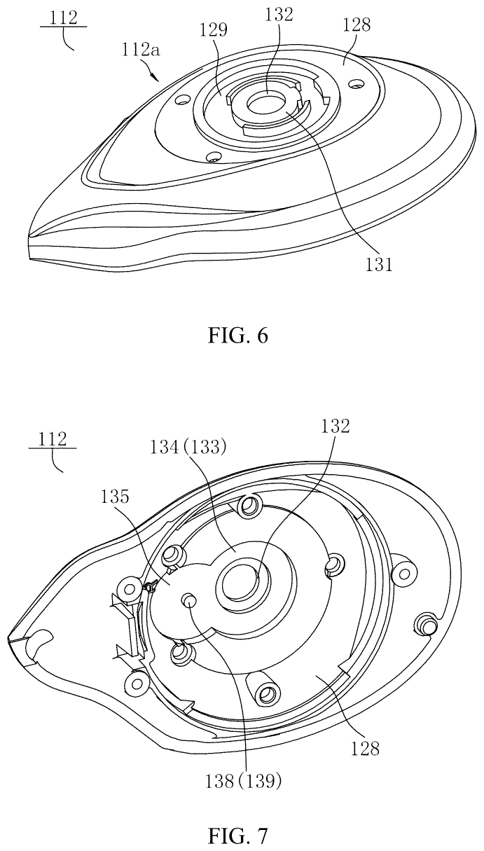

FIG. 1 is a perspective view of a fishing reel of the present disclosure as viewed from a second end portion 103. FIG. 2 is a perspective view of the fishing reel as viewed from a first end portion 102. FIG. 3 and FIG. 4 are sectional views of a device for braking dial adjustment of a fishing reel. In FIG. 3 and FIG. 4, a section is taken along an axis of a spool shaft 108. In addition, for convenience of illustration, these figures mainly illustrate the structures on the side of the first end portion 102. FIG. 6 and FIG. 7 are perspective views of a side cover 112 of the first end portion 102.

Referring to FIG. 1 to FIG. 7, and mainly referring to FIG. 1 to FIG. 4, a fishing reel according to an embodiment of the present disclosure is described. The fishing reel according to the embodiment, for example, may be a baitcasting reel, and a rotation speed of the spool shaft 108 is controlled by electromagnetic braking.

The fishing reel according to the embodiment comprises a body 101, a first end portion 102, a second end portion 103, a spool portion 104, a handle 105, a rotation transmission mechanism (not shown) for transmitting a rotation motion of the handle 105 to the spool portion 104, and a brake system 106 (braking portion) for braking rotation of the spool portion 104. The body 101 serves as a whole frame to support the fishing reel. The first end portion 102 is mounted at an axial end of the body 101, and furthermore, the brake system 106 is mainly mounted at the first end portion 102. The second end portion 103 is mounted at the other axial end of the body 101, and furthermore, the rotation transmission mechanism is accommodated in the second end portion 103. The handle 105 is mounted on an axial outer side of the second end portion 103 (that is, the side opposite to the body 101), and the handle 105 is in transmission connection with the spool portion 104 via the rotation transmission mechanism. A specific structure of the rotation transmission mechanism may be, for example, a well-known gear transmission mechanism of the existing fishing reel, so the structure will not be described in detail here. The spool portion 104 is rotatably mounted on the first end portion 102 and the second end portion 103 through a shaft supporting portion 107. The shaft supporting portion 107 is provided with a first bearing 107a and a second bearing (not shown), the first bearing 107a is mounted at the first end portion 102, and the second bearing is mounted at the second end portion 103 coaxially with the first end portion 102. The spool portion 104 is provided with a spool shaft 108 and a spool cylinder 109 coaxially sleeved over the spool shaft 108 and rotating together with the spool shaft 108, and the spool shaft 108 of the spool portion 104 and the handle 105 are connected via the rotation transmission mechanism. In addition, both axial ends of the spool shaft 108 are rotatably mounted on the first bearing 107a and the second bearing respectively, so that when the handle 105 rotates, the spool shaft 108 and the spool cylinder 109 rotate together. A fishing line (not shown) is wound around the spool cylinder 109, and the fishing line is retrieved or released with the rotation of the spool cylinder 109.

Structures of the brake system 106 (also called “braking portion”) of the fishing reel will be mainly described hereinafter. Specifically, in the brake system 106 of the fishing reel according to the embodiment, in addition to the function of controlling the rotation speed of the spool shaft 108, the brake system 106 further has the function of adjusting a braking force. That is, the fishing reel of the embodiment is provided with a braking dial adjusting device 110, and the magnitude of a braking force of the brake system 106 is adjusted by the braking dial adjusting device 110.

Mainly referring to FIG. 3 and FIG. 4, as mentioned above, the brake system 106 of the fishing reel is mainly mounted at the first end portion 102. Specifically, the first end portion 102 is provided with an end cover 111 and a side cover 112. The end cover 111 may be mounted to the side cover 112 by a well-known connecting structure such as screw connection, and the side cover 112 covers the end cover 111 from an outer side of the end cover 111 and may be mounted to an axial end of the body 101 by a snap-fit method, for example. The brake system 106 is provided with a mounting base 113, a coil 114, a magnet 115 and a control panel 116. The mounting base 113 is arranged at an inner side of the end cover 111 of the first end portion 102 (i.e., the side opposite to the side cover 112). The mounting base 113 may be mounted at the inner side of the end cover 111 of the first end portion 102 by a screw. The coil 114 is mounted on the mounting base 113, and the magnet 115 is mounted on the spool shaft 108. The coil 114 and the magnet 115 are opposite to each other in the radial direction of the spool shaft 108. The control panel 116 is mounted on the mounting base 113 and has a braking-dial input portion 117 for switching a level of a braking force generated by the coil 114 and the magnet 115. The braking-dial input portion 117 comprises, for example, braking-dial switches (braking-dial resistors) arranged at an edge of the control panel 116. By rotating these switches, their on-time or resistance value is varied, thereby adjusting the level of the braking force.

In the fishing reel of the embodiment, the level of the braking force of the brake system 106 is adjusted by the braking dial adjusting device 110. The braking dial adjusting device 110 of the embodiment comprises a knob 118, a first transmission member 119 and a second transmission member 120. The knob 118 is rotatably mounted to a top portion 112a of the side cover 112 opposite to the end cover 111. An axial end of the first transmission member 119 is coaxially connected with the knob 118, and the other end of the first transmission member extends towards the end cover 111. An axial end of the second transmission member 120 is in transmission connection with the first transmission member 119, and the other end of the second transmission member penetrates through the end cover 111 and is connected with the braking-dial input portion 117 of the control panel 116.

Compared with a conventional way that the knob 118 in the braking dial adjusting device 110 of the fishing reel is arranged at an edge of an end portion of the fishing reel, the braking dial adjusting device 110 of the embodiment is arranged at the top portion 112a of the side cover 112 of the first end portion 102, and is connected with the braking-dial switch of the braking-dial input portion 117 arranged at the edge of the control panel 116 through the first transmission member 119 and the second transmission member 120 as transmission mechanisms, not only can the gear of the brake system 106 be adjusted, but also the knob 118 for adjusting the braking dial can be operated more easily.

For example, when an angler operates the fishing reel, the palm of one hand of the angler is abutted against the top portion 112a of the side cover 112 of the first end portion 102 (that is, at a rotation center of the entire fishing reel) and then holds the fishing reel. In a state that the angler holds the knob 118, as the knob 118 is arranged on the top portion 112a of the side cover 112, while the angler's palm rests against the knob 118, and it is difficult for the palm of the angler to directly operate the knob 118, mis-operation can be suppressed. In addition, since the knob 118 is arranged at the top portion 112a of the side cover 112, compared with a case where the knob 118 is arranged at the edge, a size of the knob 118 can be appropriately increased while keeping smooth transition between the knob 118 and the side cover 112, thus making it easier for the user to grasp the knob 118.

Therefore, in the braking dial adjusting device 110 of the embodiment, the knob 118 is arranged on the top portion 112a of the side cover 112 of the first end portion 102, so that the knob 118 for adjusting the braking dial can be operated more easily.

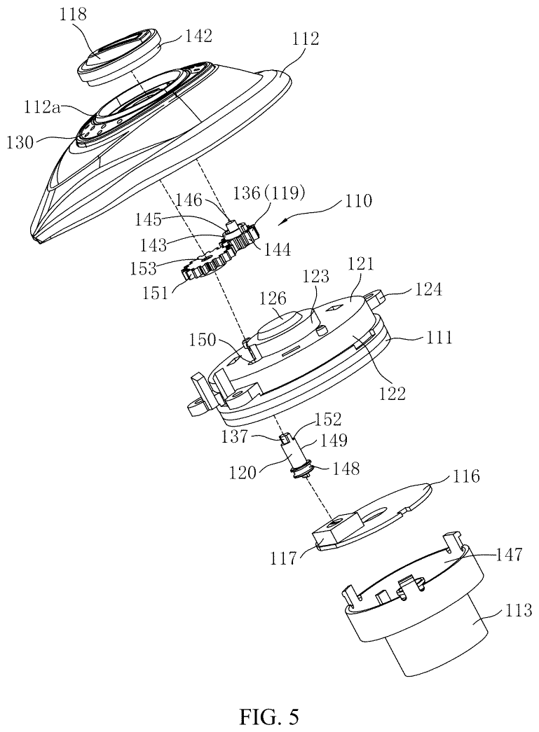

With continued reference to FIG. 5, and with auxiliary reference to FIG. 3 and FIG. 4, the end cover 111 is generally disc-shaped when viewed from the top. The end cover 111 is provided with a base portion 121, an outer side wall 122 and a middle wall 123, which are integrally formed. The base portion 121 has a substantially annular flat-plate shape. The outer side wall 122 surrounds the base portion 121 and protrudes from the base portion 121 in a direction perpendicular to the base portion 121. For example, the outer side wall 122 is formed to extend toward an axial middle portion of the body 101 in a state that the end cover 111 is mounted to the side cover 112. The outer side wall 122 is formed with a plurality of mounting lugs 124 at intervals in a circumferential direction, and the end cover 111 is mounted to the side cover 112 via these mounting lugs 124. The middle wall 123 is formed in a middle portion of the base portion 121. The middle wall 123 starts from the base portion 121 and protrudes from the base portion 121 in the axial direction, that is, both ends of the middle wall 123 protrude from the base portion 121 in the axial direction. An axial end of the middle wall 123 extends toward the axial middle portion of the body 101, and the other axial end of the middle wall 123 extends toward an outer side of the body 101. An accommodating cavity 125 is formed at an inner side of the middle wall 123, and the first bearing 107a of the shaft supporting portion 107 for supporting an axial end of the spool shaft 108 is embedded in the accommodating cavity 125. Furthermore, one end of the middle wall 123 extending toward the outer side of the body 101 is sealed by a sealing wall 126.

An outer side of the side cover 112 of the first end portion 102 is arc-shaped as a whole to conform to a shape of the palm of the angler. In addition, in order to roughly match the shape of the palm of the user when grasping the fishing reel, the top portion 112a of the side cover 112 protrudes toward the outer side (that is, the side cover 112 protrudes toward the side opposite to the end cover 111). The top portion 112a of the side cover 112 and the sealing wall 126 formed in the end cover 111 are opposite to each other in the axial direction, that is, a rotation center (of the spool shaft 108) of the fishing reel passes through the top portion 112a of the side cover 112. Furthermore, since the middle wall 123 of the end cover 111 protrudes toward the top portion 112a of the side cover 112, the middle wall 123 of the end cover 111 can be avoided by protruding the top portion 112a of the side cover 112 toward the outer side, and a space 127 for mounting the knob 118 can be formed. When the side cover 112 covers the end cover 111, the space 127 is formed between the side cover 112 and the end cover 111, and at least part of the knob 118, the first transmission member 119 and the second transmission member 120 are accommodated in the space 127.

With continued reference to FIG. 6 and FIG. 7, and with auxiliary reference to FIG. 3 to FIG. 5, the side cover 112 is provided with a supporting plate 128 at the top portion 112a, and a circular first accommodating groove 129 is formed at an outer side of the supporting plate 128. The knob 118 is accommodated in the first accommodating groove 129 and supported by the supporting plate 128 in the axial direction. In a state that the knob 118 is accommodated in the first accommodating groove 129, an outer side of the knob 118 protrudes from the outer side of the top portion 112a of the side cover 112 in the axial direction. Although it is not particularly limited, it is preferable that the outer periphery edge of the knob 118 protrudes from the outer side of the top portion 112a of the side cover 112 in a manner of smooth transition with the outer side of the top portion 112a of the side cover 112. For example, on the outer side of the top portion 112a of the side cover 112, a transition cover plate 130 may also be mounted. The transition cover plate 130 and the knob 118 are coaxially mounted to the side cover 112, and transition between the side cover 112 and the knob 118 is smoother, thus more conforming to the shape of the palm of the angler. An annular first protruding portion 131 protruding toward the outer side is formed in a middle portion of the supporting plate 128, and a round hole 132 extending in the axial direction is formed in a middle portion of the first protruding portion 131. That is, the first round hole 132 extends through the top portion 112a of the side cover 112 in the axial direction. The first round hole 132 and the first accommodating groove 129 are approximately coaxial. In addition, when the side cover 112 covers the end cover 111, the first round hole 132 is approximately coaxial with the middle wall 123 of the end cover 111. The first round hole 132 is configured for making a part of the knob 118 penetrate through the side cover 112 and connect with the first transmission member 119 accommodated in the space 127. In addition, the first round hole 132 may also be configured for guiding rotation of the first transmission member 119.

A second accommodating groove 133 is formed at an inner side of the supporting plate 128 (the side opposite to the end cover 111), and the second accommodating groove 133 comprises a first groove portion 134 and a second groove portion 135 which are communicated with each other. The first groove portion 134 accommodates at least a first transmission end 136 (described later) of the first transmission member 119, and the second groove portion 135 accommodates at least a second transmission end 137 (described later) of the second transmission member 120. The first groove portion 134 and the first accommodating groove 129 are approximately coaxial, and an inner diameter of the first groove portion 134 is smaller than that of the first accommodating groove 129. In addition, the side cover 112 is formed with a cylindrical second protruding portion 138 (i.e., an example of a guide portion 139 described later) protruding toward the end cover 111 at the inner side of the supporting plate 128, more specifically, at a middle position of the second groove portion 135 of the second accommodating groove 133. The second protruding portion 138 is configured for guiding rotation of the second transmission member 120. The second protruding portion 138 and the second groove portion 135 are substantially coaxial.

With continued reference to FIG. 4, and with auxiliary reference to FIG. 3 and FIG. 5, the knob 118 is provided with a dial 140 and a shaft-shaped portion 141 integrally formed coaxially with the dial 140. The dial 140 is accommodated in the first accommodating groove 129 of the side cover 112, and a circumferential end surface of the dial 140 protrudes from the outer side of the top portion 112a of the side cover 112. On a circumferential edge of the dial 140 opposite to the side cover 112, a substantially annular abutting portion 142 is formed, and the abutting portion 142 is abutted against an area of the supporting plate 128 located at an edge of the first accommodating groove 129 in a state that the knob 118 is mounted in the first accommodating groove 129. An inner diameter of the abutting portion 142 is larger than that of the first groove portion 134. The shaft-shaped portion 141 protrudes from an inner side of the dial 140 (the side opposite to the side cover 112). A first flat key (not labeled) is formed on an outer periphery of a base end of the shaft-shaped portion 141 connected with the dial 140. A threaded hole (not labeled) is coaxially formed at a tail end of the shaft-shaped portion 141.

The first transmission member 119 is mounted to the knob 118 through the first round hole 132. An axial end of the first transmission member 119 is provided with a cylindrical portion 143, and an outer diameter of the cylindrical portion 143 is the same as an inner diameter of the first round hole 132. The other axial end of the first transmission member 119 is provided with a first transmission end 136, the first transmission end 136 is formed with a first gear portion 144, and the first gear portion 144 and the cylindrical portion 143 are integrally formed coaxially. A second round hole 145 is formed in a middle portion of the cylindrical portion 143, and a size of the second round hole 145 is the same as that of the shaft-shaped portion 141 of the knob 118. The second round hole 145 extends from one end of the cylindrical portion 143 to an approximately middle position of the first gear portion 144 in the axial direction thereof. In addition, a part of the cylindrical portion 143 is cut to form a first keyway (not labeled). The first transmission member 119 is formed with a counter bore (not labeled) at one side of the first gear portion 144, and the counter bore is coaxially communicated with the second round hole 145.

Mainly referring to FIG. 5 and with auxiliary reference to FIG. 4, the knob 118 and the first transmission member 119 may be assembled in the following manner.

Firstly, the first transmission end 136 of the first transmission member 119 is placed in the second accommodating groove 133 from an inner side of the side cover 112, and the cylindrical portion 143 of the first transmission member 119 is coaxially inserted into the first round hole 132.

Then, the knob 118 is placed in the first accommodating groove 129 from an outer side of the side cover 112, so that the shaft-shaped portion 141 of the knob 118 is coaxially inserted into the cylindrical portion 143 (that is, inserted into the second round hole 145 of the cylindrical portion 143), and the first flat key at the base end of the shaft-shaped portion 141 of the knob 118 is inserted into the cylindrical portion 143.

Next, from the inner side of the side cover 112, a screw (also called “first screw 146” for convenience of distinction) is threadedly connected with the threaded hole formed in the shaft-shaped portion 141 of the knob 118 through the counter bore of the first transmission member 119 and the second round hole 145, thereby locking the first transmission member 119 and the knob 118.

That is, the first transmission member 119 and the knob 118 are respectively fixed on the top portion 112a of the side cover 112 with the side cover 112 sandwiched therebetween in the axial direction, and more specifically, with the supporting plate 128 of the top portion 112a of the side cover 112 sandwiched therebetween in the axial direction. In addition, in a state that the first transmission member 119 and the knob 118 sandwich the supporting plate 128 together, a gap may be provided between each of the first transmission member 119 and the knob 118, and the supporting plate 128 in the axial direction, for example, a gap in a range from 0.2 mm to 0.5 mm, and further, a gap in a range from 0.1 mm to 0.3 mm. This gap may be formed by making an axial length of the cylindrical portion 143 greater than a thickness of the first protruding portion 131.

Therefore, by coaxially accommodating the cylindrical portion 143 of the first transmission member 119 in the first round hole 132 and rotating the cylindrical portion 143 around an axis of the first round hole 132, the first transmission member 119 and the knob 118 can be rotated with high accuracy relative to the side cover 112. Furthermore, by forming the gap between each of the first transmission member 119 and the knob 118, and the supporting plate 128 in the axial direction, it is possible to suppress excessive friction between each of the first transmission member 119 and the knob 118, and the supporting plate 128.

In the fishing reel of the embodiment, the side cover 112 and the knob 118 are located at the outer side of the end cover 111, the mounting base 113 of the braking portion is mounted at the inner side of the end cover 111, while the control panel 116 is mounted in the mounting cavity 147 of the mounting base 113. Furthermore, as described above, an axial end of the second transmission member 120 is in transmission connection with the first transmission member 119, and the other end of the second transmission member penetrates through the end cover 111 and is connected with the braking-dial input portion 117 of the control panel 116. The second transmission member 120 is generally pin-shaped as a whole. The second transmission member 120 is provided with a drive end 148, a middle portion 149 and a second transmission end 137 in sequence in the axial direction, and the drive end 148, the middle portion 149 and the second transmission end 137 are coaxially and integrally formed. The drive end 148 of the second transmission member 120 is accommodated in the mounting cavity 147 and connected with the braking-dial input portion 117 of the control panel 116. The manner for the connection between the drive end 148 of the second transmission member 120 and the braking-dial input portion 117 may be determined according to the specific element served as the braking-dial input portion 117. For example, in the case of using a resistor, the drive end 148 of the second transmission member 120 may be formed with a thin protrusion (not labeled) and inserted into a switching groove of the resistor. The middle portion 149 of the second transmission member 120 is respectively connected with the drive end 148 located at the inner side of the end cover 111 and the second transmission end 137 located at the outer side of the end cover 111 via a through hole 150 provided in the end cover 111. In addition, an outer diameter of the drive end 148 is larger than an outer diameter of the middle portion 149 and an inner diameter of the through hole 150, thereby suppressing the second transmission member 120 from being pulled out toward the outer side relative to the end cover 111.

The second transmission end 137 of the second transmission member 120 is in transmission connection with the first gear portion 144 of the first transmission member 119. Specifically, the braking dial adjusting device 110 of the embodiment further comprises a gear member 151 engaged with the first gear portion 144, and the gear member 151 is coaxially mounted to the second transmission end 137 of the second transmission member 120. Further, the gear member 151 rotates around the second protruding portion 138 (i.e., the guide portion 139), so that the second transmission member 120 also rotates around the second protruding portion 138 served as the guide portion 139 via the gear member 151. The second transmission end 137 of the second transmission member 120 is generally shaft-shaped, and an outer diameter of the second transmission end 137 of the second transmission member 120 is smaller than an outer diameter of the middle portion 149 of the second transmission member 120, thereby forming a supporting step 152 between the middle portion 149 and the second transmission end 137. In addition, the second transmission end 137 is also formed with a second flat key (not labeled), and correspondingly, a mounting hole 153 is coaxially formed in a middle portion of the gear member 151, and the mounting hole 153 is cut to form a second keyway (not labeled). An outer diameter of the second transmission end 137, an inner diameter of the mounting hole 153 and an outer diameter of the second protruding portion 138 are the same. In addition, when the assembly is completed, that is, when the drive end 148 of the second transmission member 120 is connected with the braking-dial input portion 117 of the control panel 116 and the end cover 111 is covered by the side cover 112, a distance between a surface of the supporting step 152 formed at the second transmission member 120 and an inner side surface of the supporting plate 128 formed at the side cover 112 in the axial direction is greater than a thickness of the gear member 151 by, for example, 0.2 mm to 0.5 mm.

Mainly referring to FIG. 5 and with auxiliary reference to FIG. 4, the second transmission member 120 and the gear member 151 may be assembled in the following manner.

Firstly, the drive end 148 of the second transmission member 120 is vertically inserted into the braking-dial input portion 117 of the control panel 116 mounted in the mounting cavity 147 of the mounting base 113.

Then, the mounting base 113 is mounted to the end cover 111 from the outer side to the inner side in the axial direction in such a way that the middle portion 149 of the second transmission member 120 passes through the through hole 150 of the end cover 111. In this case, the second transmission member 120 is held by the through hole 150, and the second transmission end 137 is located at the outer side of the end cover 111.

Next, the mounting hole 153 of the gear member 151 is aligned with the second transmission end 137 of the second transmission member 120, and the second keyway of the gear member 151 is aligned with the second flat key of the second transmission end 137, so that the gear member 151 is mounted to the second transmission member 120 and the gear member 151 is abutted against the supporting step 152 of the second transmission member 120.

Then, the cylindrical second protruding portion 138 (guide portion 139) located at the inner side of the supporting plate 128 of the side cover 112 is aligned with and inserted into the mounting hole 153 of the gear member 151, so that the end cover 111 is mounted to the side cover 112, and the gear member 151 is accommodated in the second accommodating groove 133 at the inner side of the supporting plate 128. In addition, when the side cover 112 covers the end cover 111, the knob 118 is rotated as necessary to engage the first gear portion 144 of the first transmission member 119 with the gear member 151.

When the assembly is completed, the gear member 151 is mounted to the second protruding portion 138 through an axial end of the mounting hole 153, and can rotate around the second protruding portion 138. An axial end of the second transmission member 120 (namely, second transmission end 137) is inserted into the other axial end of the mounting hole 153.

When the assembly is completed, the first transmission member 119 and the knob 118 rotate in linkage when the dial 140 of the knob 118 located at the outer side of the side cover 112 is rotated. The rotation of the first transmission member 119 is transmitted to the gear member 151 mounted on the second transmission member 120 via the first gear portion 144, so that the gear member 151 rotates with the rotation of the first transmission member 119. Further, the second transmission member 120 and the gear member 151 rotate in linkage, thereby driving the braking-dial switch of the braking-dial input portion 117 arranged on the control panel 116.

In the braking dial adjusting device 110 of the embodiment, the knob 118 is arranged on the top portion 112a of the side cover 112 of the first end portion 102, so that the knob 118 for adjusting the braking dial can be operated more easily. In the state that the angler holds the knob 118, as the knob 118 is arranged on the top portion 112a of the side cover 112, while the angler's palm rests against the knob 118, and it is difficult for the palm of the angler to directly operate the knob 118, mis-operation can be suppressed. In addition, since the knob 118 is arranged at the top portion 112a of the side cover 112, compared with a case where the knob 118 is arranged at the edge, a size of the knob 118 can be appropriately increased while keeping smooth transition between the knob 118 and the side cover 112, thus making it easier for the user to grasp the knob 118.

In addition, by making the top portion 112a of the side cover 112 in an arc shape protruding toward the outer side, and the outer side of the knob 118 protruding from the outer side of the top portion 112a of the side cover 112, it can more fit with the shape of the palm of the angler, and gripping feeling and comfort of the angler can be improved.

In the braking dial adjusting device 110 of the embodiment, the first accommodating groove 129 for accommodating the knob 118 is formed at the outer side of the supporting plate 128 of the top portion 112a of the side cover 112, so that the knob 118 can be prevented from protruding excessively relative to the top portion 112a of the side cover 112, and the mis-operation of the knob 118 by the angler can be suppressed. In addition, by making the outer peripheral edge of the knob 118 be in smooth transition with the outer side of the top portion 112a of the side cover 112, the gripping feeling and comfort of the angler can be further improved, and the overall aesthetic feeling of the fishing reel can be improved.

In the braking dial adjusting device 110 of the embodiment, the first groove portion 134 for accommodating the first transmission end 136 of the first transmission member 119 and the second groove portion 135 for accommodating the second transmission end 137 of the second transmission member 120 are formed at the inner side of the supporting plate 128, so that the first transmission member 119 and the second transmission member 120 can be compactly accommodated, the space 127 formed between the side cover 112 and the end cover 111 can be reduced to a certain extent, and the side cover 112 can be prevented from protruding too much to the outer side.

Furthermore, the inner diameter of the first groove portion 134 is smaller than that of the first accommodating groove 129, and in the state that the knob 118 is mounted in the first accommodating groove 129, the abutting portion 142 of the knob 118 is abutted against an area of the supporting plate 128 located at an edge of the first accommodating groove 129, the knob 118 can be offset from a thinner part of the supporting plate 128 and abutted against the supporting plate 128, and the supporting plate 128 can be suppressed from being depressed toward the inner side in the axial direction.

In addition, by forming the first protruding portion 131 protruding toward the outer side in the middle portion of the supporting plate 128, the supporting plate 128 can be strengthened to a certain extent, and the first groove portion 134 can be deepened, so that the first transmission member 119 can be smoothly mounted, and contact of the first transmission member 119 with the sealing wall 126 of the end cover 111 in the axial direction can be suppressed. Moreover, the first transmission member 119 and the sealing wall 126 can be prevented from contacting each other when the supporting plate 128 is depressed toward the inner side in the axial direction.

In the braking dial adjusting device 110 of the embodiment, the first transmission member 119 can be directly guided by rotating the cylindrical portion 143 of the first transmission member 119 around an axis of the first round hole 132 formed in the side cover 112, so that the first transmission member 119 itself can be rotated with high precision. The guide portion 139 formed at the side cover 112 directly guides the rotation of the gear member 151 mounted to the second transmission member 120, so that the second transmission member 120 itself can be rotated with high precision. Moreover, since the first round hole 132 and the guide portion 139 are formed in the same member (that is, the side cover 112), the position precision between the first round hole 132 and the guide portion 139 can be improved, and the transmission precision of the first transmission member 119 and the second transmission member 120 can be further improved.

Furthermore, by providing the gap between each of the first transmission member 119 and the knob 118, and the supporting plate 128 in the axial direction, rotation smoothness of the knob 118 can be improved, and the friction between the knob 118 and the supporting plate 128 can be suppressed from being too large.

In addition, by making the distance between the surface of the supporting step 152 of the second transmission member 120 and the inner side surface of the supporting plate 128 in the axial direction larger than the thickness of the gear member 151, it is possible to suppress excessive friction between the gear member 151 and the supporting plate 128. In addition, even when the supporting plate 128 is recessed toward the inner side in the axial direction, it is possible to suppress the gear member 151 from being stuck caused due to that the gear member 151 is clamped by the second transmission member 120 and the supporting plate 128.

It should be noted that in the above embodiment, although it is described that the coil 114 of the braking portion is mounted on the mounting base 113 and the magnet 115 is mounted on the spool shaft 108, it is not limited to this. Alternatively, the magnet 115 may be mounted on the mounting base 113, while the coil 114 may be mounted on the spool shaft 108.

In the above embodiment, although the first transmission member 119 is provided with the cylindrical portion 143 and the knob 118 is provided with the shaft-shaped portion 141, it is not limited to this. It is also possible that the first transmission member 119 is provided with the shaft-shaped portion 141 and the knob 118 is provided with the cylindrical portion 143. In this case, it is also possible that the knob 118 rotates around an axis of the first round hole 132.

In the above embodiment, an example in which the cylindrical second protruding portion 138 is formed at the inner side of the side cover 112 in the axial direction as the guide portion 139 for the gear member 151 mounted on the second transmission member 120 has been described, but it is not limited to this. For example, a round hole may be formed at the axial inner side of the side cover 112, and correspondingly, the second protruding portion 138 may be formed at the gear member 151, and the second protruding portion 138 of the gear member 151 may be inserted into the round hole.

In the above embodiment, although an example in which the first transmission member 119 is mounted to the knob 118 through a first screw 146 has been described, it is not limited to this. For example, the first transmission member 119 may also be integrally formed with the knob 118, in other words, the first gear portion 144 may be directly formed on the knob 118.

In the above embodiment, although an example in which the gear member 151 is mounted on the second transmission end 137 of the second transmission member 120 and is in transmission connection with the first transmission member 119 through the gear member 151 has been described, it is not limited to this. For example, the second transmission member 120 may also be directly integrated with the gear member 151, in other words, the second gear portion may be directly formed at the second transmission end 137 of the second gear member 151, and the second gear portion engages with the first gear portion 144.

In the above embodiment, although an example that the first transmission member 119 and the second transmission member 120 are connected by gear transmission has been described, it is not limited to this. The first transmission member 119 and the second transmission member 120 may also be connected by belt transmission. Examples of the belt transmission may comprise leather belts and synchronous belts. Taking the leather belt as an example, a V-shaped groove for mounting an O-shaped belt may be formed at the first transmission end 136 of the first transmission member 119 and the second transmission end 137 of the second transmission member 120 respectively.

Although the embodiments of the present disclosure have been shown and described, those of ordinary skills in the art may understand that various changes, amendments, substitutions and modifications can be made to these embodiments without departing from the principles and purposes of the present disclosure, and the scope of the present disclosure is limited by the claims and equivalents thereof.

What is claimed is:

1. A device for braking dial adjustment of a fishing reel, wherein the fishing reel comprises:
a body;
a first end portion provided with an end cover and a side cover, wherein the end cover is mounted at an axial end of the body, and the side cover covers the end cover;
a spool portion provided with a spool shaft, wherein an axial end of the spool shaft is rotatably mounted on the end cover; and
a braking portion provided with a mounting base, a coil, a magnet and a control panel, wherein the mounting base is arranged on one side of the end cover opposite to the side cover; the coil is mounted on one of the mounting base and the spool shaft, the magnet is mounted on another of the mounting base and the spool shaft, and the coil and the magnet are opposite to each other along a radial direction of the spool shaft; and the control panel is mounted on the mounting base and has a braking-dial input portion for switching a level of a braking force generated by the coil and the magnet;
wherein, the device for braking dial adjustment of a fishing reel comprises:
a knob rotatably mounted to a top portion of the side cover;
a first transmission member, wherein an axial end of the first transmission member is coaxially connected with the knob, and another end of the first transmission member extends towards the end cover; and
a second transmission member, wherein an axial end of the second transmission member is in transmission connection with the first transmission member, and another end of the second transmission member penetrates through the end cover and is connected with the braking-dial input portion.

2. The device for braking dial adjustment of a fishing reel according to claim 1, wherein the top portion of the side cover protrudes toward an outer side as a side opposite to the end cover; and
an outer side of the knob protrudes from an outer side of the top portion of the side cover.

3. The device for braking dial adjustment of a fishing reel according to claim 2, wherein the side cover is provided with a supporting plate at the top portion, the supporting plate is provided with a first accommodating groove at the outer side, and the knob is accommodated in the first accommodating groove and supported by the supporting plate in an axial direction; and
in a state that the knob is accommodated in the first accommodating groove, an outer periphery edge of the knob is in smooth transition with the outer side of the top portion of the side cover.

4. The device for braking dial adjustment of a fishing reel according to claim 3, wherein a first protruding portion protruding toward the outer side is provided in a middle portion of the supporting plate, and a first round hole extending in the axial direction is provided in the first protruding portion;
the first transmission member is mounted to the knob through the first round hole; and
the first transmission member or the knob is rotatable around an axis of the first round hole.

5. The device for braking dial adjustment of a fishing reel according to claim 4, wherein the axial end of the first transmission member is provided with a cylindrical portion, which is coaxially accommodated in the first round hole and rotatable around the axis of the first round hole; and
one end of the knob opposite to the side cover is provided with a shaft-shaped portion, and the shaft-shaped portion is coaxially inserted into the cylindrical portion and locked.

6. The braking dial adjusting device according to claim 3, wherein the first transmission member and the knob are respectively fixed on the top portion of the side cover with the supporting plate sandwiched between the first transmission member and the knob in the axial direction; and
a gap is provided between each of the first transmission member and the knob, and the supporting plate in the axial direction.

7. The device for braking dial adjustment of a fishing reel according to claim 1, wherein the side cover is provided with a guide portion at an inner side of the side cover, and the guide portion is configured for guiding rotation of the second transmission member.

8. The device for braking dial adjustment of a fishing reel according to claim 7, wherein the first transmission member is provided with a first transmission end, and the first transmission end is provided with a first gear portion;
the second transmission member is provided with a second transmission end, and the second transmission end is coaxially provided with a gear member; and
the gear member is rotatable around the guide portion.

9. The braking dial adjusting device according to claim 8, wherein the side cover is provided at the inner side with a cylindrical second protruding portion protruding toward the end cover, and the second protruding portion serves as the guide portion; and
the gear member is provided with a mounting hole, the second protruding portion is inserted into the mounting hole, and the gear member is rotatable around the second protruding portion.

10. The device for braking dial adjustment of a fishing reel according to claim 9, wherein the second transmission member is provided with a supporting step for supporting the gear member;
the side cover is provided with a supporting plate at the top portion, and the second protruding portion is provided at an inner side of the supporting plate; and
in a state that the second transmission member is connected with the braking-dial input portion and the side cover covers the end cover, a distance between a surface of the supporting step and a surface of the inner side of the supporting plate in the axial direction is greater than a thickness of the gear member.
